(19) United States
(12) Patent Application Publication
(10) Pub. No.: US 2023/0194670 A1
(43) Pub. Date: Jun. 22, 2023

(54) BAFFLE OF A DETECTION DEVICE FOR AUTOMOTIVE VEHICLE

(71) Applicant: AGC GLASS EUROPE, Louvain-la-Neuve (BE)

(72) Inventors: Meijie LI, Louvain-La-Neuve (BE); Yannick SARTENAER, Vedrin (BE)

(73) Assignee: AGC GLASS EUROPE, Louvain-la-Neuve (BE)

(21) Appl. No.: 17/998,868

(22) PCT Filed: May 21, 2021
(86) PCT No.: PCT/EP2021/063632

§ 371 Date: Nov. 15, 2022

(30) Foreign Application Priority Data
May 25, 2020 (EP) 20176248.1

(51) Int. Cl. G01S 7/481; G01S 17/931

(52) U.S. Cl. CPC G01S 7/4813; G01S 17/931; G01S 2013/93276

(57) ABSTRACT

A detection device that includes a sensing device operating within a wavelength range, a cover transparent at the operating wavelength range and a baffle placed to efficiently reduce reflection noise with no impact or limited impact on an implemented design of such integrated sensing devices.

### FIELD OF THE INVENTION

The invention relates to a detection device operating with waves within a determined wavelength range comprising a sensing device, a cover and a baffle. The cover is transparent at the operating wavelength range of the sensing device.

More particularly, the present invention relates to a lidar (light detection and ranging) as sensing device.

### BACKGROUND OF THE INVENTION

Today, the tendency is to use autonomous vehicles. An autonomous vehicle, also called driverless vehicle, self-driving vehicle or robotic vehicle, is a vehicle able to analyze its environment by itself in order to navigate without human input. An automotive vehicle includes cars, vans, lorries, motorbikes, buses, trams, trains, airplanes, helicopters and the like.

An autonomous vehicle detects its surroundings using various sensing devices such as radar, lidar, camera, sonar. Information received through the sensing devices are then processed to determine the navigation path of the vehicle, allowing the vehicle to navigate without collision with both fixed and moving objects of its environment.

ADAS (Advanced Driver Assistance System) also needs detection techniques to assist the driver based on the surroundings of the vehicle.

Among all detection techniques, lidar is a very useful one to offer 3D images with good resolution. Lidar is a technology that measures distance to a target by illuminating the target with laser light and measuring the reflected light with a sensor. Differences in laser return times and wavelengths can then be used to make digital 3D representations of the target. Lidar is also called 3D laser scanning. There exists several types of lidars: scanning, rotating, flashing or solid state lidars. While scanning and rotating lidars use continuous laser, flashing and solid state lidars use laser pulses.

The sensing devices can be integrated to a vehicle as a stand-alone device. It is then enclosed by a protective housing comprising a cover. They can also be integrated behind existing covers, such as windshield, backlite, sidelite. They can also be integrated behind trim elements. A trim element for automotive refers to an item that can be added to the interior or the exterior of a vehicle to increase its appeal or to mask some unaesthetic parts of the vehicle.

Depending on the type of integration, the cover can be made of glass, plastic and/or other materials, as long as it is transparent to the operating wavelength range of the sensing device. It can have many shapes. It can be flat or bent. The cover can be placed perpendicular to the sensing axis of the sensing device or at a defined angle.

The presence of a cover in front of the sensing devices creates reflection of the signal emitted by the sensing device. This signal can then be reflected to the sensing device, generating strong reflection noise, perturbing the real detection signal.

Integrating a sensing device to a vehicle may lead to the presence of a baffle close to the sensing device itself. This baffle could be a part of a bracket to integrate the sensing device, or any surrounding components if there is no bracket. The baffle could more generally be part of the housing and/or packaging used to protect the sensing device. The surface of this baffle can scatter and/or reflect the signal emitted by the sensing device, causing additional reflection noise.

In order to avoid this reflection noise, efforts have been made to reduce the reflection and/or scattering of the cover by applying a treatment on the cover, such as antireflection coatings. However it is practically difficult to completely avoid surface reflection. The reflection noise can be reduced but hardly completely eliminated. Besides surface treatment increases both production difficulty and cost. Moreover surface treatment may have an impact on specific characteristics of the cover, such as reduction of its mechanical or thermal resistance.

Another possibility to reduce the noise is to modify the baffle surface scattering profile and reflection efficiency. However it is not efficient, when the reflection noise is much stronger than the real detection signal. Moreover baffle surface modification might introduce limitations in product design and fabrication, and increase the production cost.

Another way to deal with reflection noise is to adjust the orientation of the sensing device with respect to the cover. However it is usually not compatible with constraints due to the integration of the sensing device into a vehicle.

### SUMMARY OF THE INVENTION

The present invention proposes a solution to efficiently reduce this reflection noise with no or limited impact on the implemented design of such integrated sensing devices.

The invention concerns a detection device. This detection device comprises a sensing device. This sensing device comprises one or more emitter(s) emitting along an emitting axis, and one or more receiver(s) receiving along a receiving axis. Both the emitter(s) and the receiver(s) operate within a wavelength range. The sensing device has a sensing axis defined as the center axis between the emitting axis and the receiving axis. The sensing device also has a field of view and an opening through which a wave within the wavelength range passes.

The detection device also comprises a cover facing its opening. The cover defines an angle A with the sensing axis of the sensing device. The cover is obviously transparent at the operating wavelength range of the sensing device.

The detection device also comprises a baffle. This baffle is placed at a distance d from the sensing axis of the sensing device measured at the opening of the sensing device. The baffle extends towards the cover. The baffle defines an angle B with the cover and an angle C with the sensing axis of the sensing device. The baffle is obviously placed outside the field of view of the sensing device. The baffle could be flat, tilted or bent.

The distance d is determined so that the intensity of the wave which is scattered by the baffle back to the cover and then reflected by the cover to be detected by the receiver of the sensing device is maximum 50%, preferably 20%, more preferably 10%, even more preferably 0% of the intensity of the wave emitted by the emitter of the sensing device and then reflected by the cover towards the baffle.

The distance d is indeed required to be below a certain value called maximal distance (max. distance), so that there is no or low baffle reflection noise sent back to the sensing device. The maximal distance depends on system designs, like the sensing device design, the baffle surface shape and scattering/reflecting properties, the baffle angle B with the cover, the baffle angle C with the sensing axis of the sensing device, the cover shape and surface reflection properties, the distance s between the sensing device and the cover, and the angle A between the cover and the sensing axis of the sensing device.

According to one embodiment of the present invention, the baffle is parallel to the sensing axis of the sensing device.

According to one embodiment of the present invention, the baffle can be part of a bracket to integrate the sensing device or any surrounding component of the sensing device. The baffle could more generally be part of the housing and/or packaging used to protect the sensing device.

According to one embodiment of the present invention, the sensing device is a radar. A radar is a detection system that uses radiowaves to determine the range, angle or velocity of surrounding objects. A radar comprises at least an emitter of radiowaves (or microwaves) and a receiver in order to determine properties of the surrounding objects. Radiowaves (pulsed or continuous) from the emitter reflect off the object and return to the receiver, giving information about the object's location and speed. With the emergence of driverless vehicles, radar is expected to assist the automated platform to monitor its environment, thus preventing unwanted incidents.

According to one embodiment of the present invention, the sensing device is a lidar. Among all detection techniques, lidar is very useful to offer 3D images with good resolution. Lidar is a technology that measures distance to a target by illuminating the target with laser light and measuring the reflected light with a sensor. Differences in laser return times and wavelengths can then be used to make digital 3D representations of the target.

The lidar can be a scanning, rotating, flashing or solid state lidar. As a radar, a lidar comprises at least an emitter and a receiver, but it makes use of other parts of the electromagnetic spectrum. The lidar uses optical waves, more predominantly infrared light from lasers.

According to a preferred embodiment of the present invention, the wavelength range of the lidar is comprised between 750 nm and 1650 nm. This range allows good detection of usual obstacles for a vehicle while staying invisible and safe for the human eye.

According to one embodiment of the present invention, the cover is made of glass. The glass sheet must obviously still be transparent to the operating wavelength range of the sensing device. The use of glass offers the possibility to be heated efficiently, for example to defrost or demist the glass itself. The glass can also be chosen for its mechanical resistance and chemical durability to the external environment. However, the cover may be made of plastic or another material, as long as it is transparent to the operating wavelength range of the sensing device.

Preferably the cover or the glass sheet has an absorption coefficient lower than 15 m⁻¹ in the wavelength range from 750 to 1650 nm. The glass can thus be a soda-lime-silica type glass, alumino-silicate, boro-silicate, . . . . Preferably, the glass sheet is an extra-clear glass.

According to one embodiment of the present invention, the cover is a portion of an automotive glazing, such as windshield, sidelite, backlite. WO2018015312 (incorporated here by reference) illustrates such kind of automotive glazing. Alternatively the cover could be placed behind an automotive glazing.

The cover can also be a portion of an automotive applique or an automotive trim element, such as a bumper, a roof, a fender. WO2018015313A1 (incorporated here by reference) illustrates such kind of trim element.

Alternatively the cover could be placed behind an automotive applique or an automotive trim element.

The invention concerns also the use of a detection device of the invention on an automotive vehicle. The sensing device of the detection device is preferably a lidar, more preferably a solid state lidar.

For purposes of summarizing the invention and the advantages achieved over the prior art, certain objects and advantages of the invention have been described herein above. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

The above and other aspects of the invention will be apparent from and elucidated with reference to the embodiment(s) described hereinafter.

### BRIEF DESCRIPTION OF THE FIGURES

The invention will now be described further, by way of examples, with reference to the accompanying drawings, wherein like reference numerals refer to like elements in the various figures. These examples are provided by way of illustration and not of limitation. The drawings are a schematic representation and not true to scale. The drawings do not restrict the invention in any way. More advantages will be explained with examples.

FIG. 1a is a general view of an embodiment of the present invention.

FIG. 1b is another embodiment of the present invention.

FIG. 2 is another embodiment of the present invention.

FIG. 3 schematically shows the scattering of the signal by the baffle.

FIGS. 4a and 4b schematically show the backscattering of the signal by the baffle.

FIGS. 5 and 6 show results of numerical simulations

### DETAILED DESCRIPTION OF ILLUSTRATIVE EMBODIMENTS

The present invention will be described with respect to particular embodiments and with reference to certain drawings but the invention is not limited thereto.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

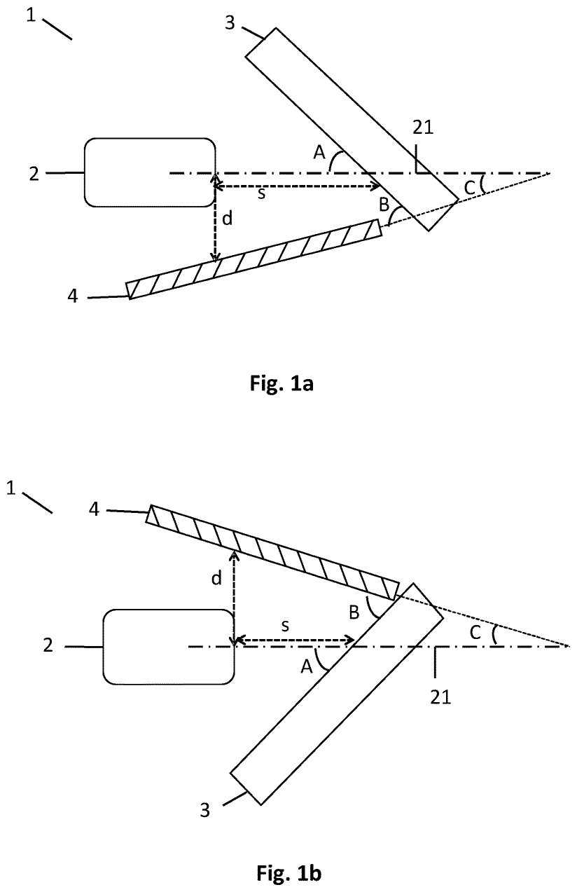

As shown on FIG. 1a, the detection device (1) comprises a sensing device (2) operating within a wavelength range. A sensing device (2) generally has an emitter (not shown on figures) emitting along an emitting axis (not shown on figures) and a receiver (not shown on figures) receiving along a receiving axis (not shown on figures). The sensing axis (21) is defined as the central axis between the emitter axis and the receiver axis. The sensing device (2) also has a determined field of view and an opening through which a wave within the wavelength range passes. This wave will propagate along the sensing axis (21).

The detection device (1) also comprises a cover (3) facing the opening of the sensing device (2), defining an angle A with the sensing axis (21) of the sensing device (2). The cover (3) is transparent at the operating wavelength range of the sensing device (2).

The detection device (1) also comprises a baffle (4). In this embodiment the baffle is placed at least partially under the sensing device (2) at a distance d from the sensing axis (21) of the sensing device (2) measured at the opening of the sensing device. The baffle (4) extends towards the cover (3). The baffle (4) defines an angle B with the cover (3) and an angle C with the sensing axis (21) of the sensing device (2). The baffle (4) is obviously placed outside the field of view of the sensing device (2).

As shown on FIG. 1b, the baffle (4) can also be placed above the sensing device (2). More generally, the baffle (4) could be placed all around the sensing axis (21) of the sensing device (2).

In a preferred embodiment, as shown on FIG. 2, the baffle (4) is parallel to the sensing axis (21) of the sensing device (2) and the baffle (4) extends to the cover (3).

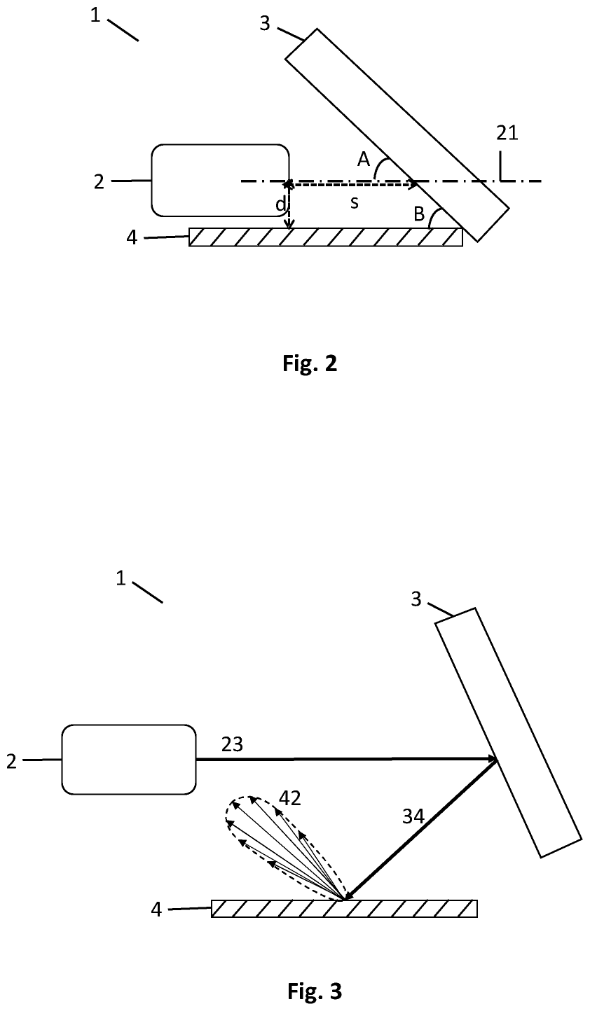

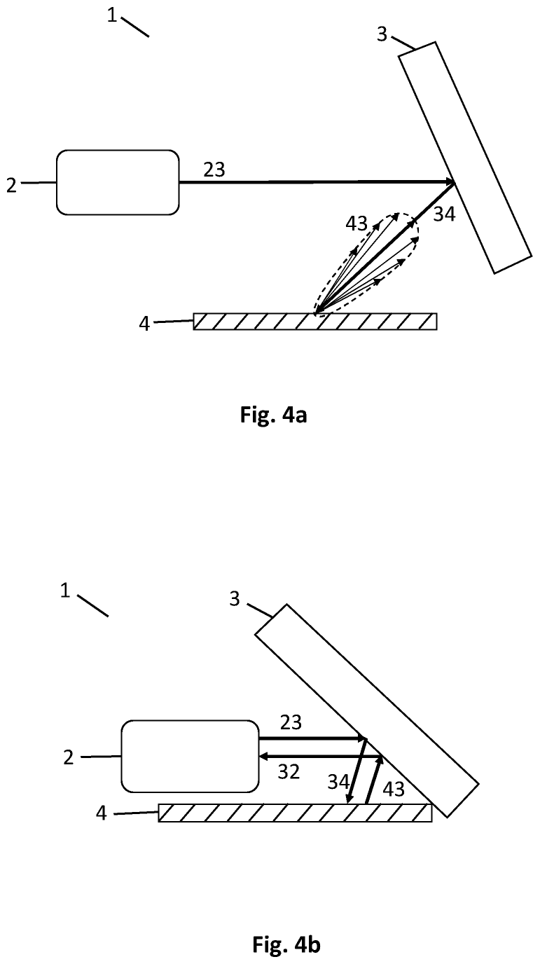

FIGS. 3, 4a and 4b only show the path of the waves schematically. The complete path including multiple reflections and scattering is only suggested.

FIG. 3 schematically shows the scattering of the signal by the baffle (4). It is commonly assumed that the main contribution to the reflection noise is the signal which is emitted (23) by the sensing device (2), then reflected (34) by the cover (3) towards the baffle (4), and then scattered (42) by the baffle (4) towards the sensing device (2). However, it appears that this path is usually outside the detection of the receiver of the sensing device (2).

FIGS. 4a and 4b schematically show the backscattering of the signal by the baffle (4). The reflection noise is mostly due to the signal which is emitted (23) by the sensing device (2), then reflected (34) by the cover (3) towards the baffle (4), then scattered (43) back to the cover (3), and then reflected (32) by the cover (3) to the receiver of the sensing device (2).

On FIG. 4b, for convenience and visibility, the backscattered signal (43) has been drawn as a single arrow and shifted of its path to distinguish the scattered signal (43 and 32) from the emitted signal (23 and 34).

It has been observed that the backscattered signal may contribute to the reflection noise. This finding eases numerical simulation of the sensing device (2), the cover (3) and the baffle (4), in order to determine the maximal distance for the distance d so that the reflection noise is eliminated, at least reduced. Such numerical simulations can be based on Fresnel coefficients and ray tracing in case of electromagnetic radiation.

For example, the sensing device (2) is a lidar with a horizontal FOV of 30° and a vertical FOV of 10°. The cover (3) is a glass sheet which is transparent to the operating wavelength range of the lidar, and of following dimensions: horizontally 135 mm and vertically 75 mm. The baffle (4) reflectivity is defined as 5% Lambertian scattering.

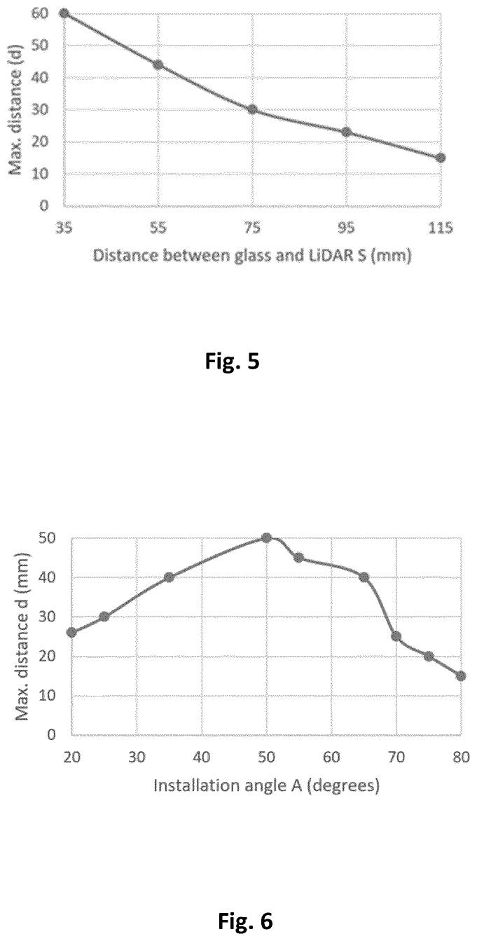

FIG. 5 shows results of numerical simulations, where the angle A between the cover (3) and the optical axis (21) of the lidar (2) is fixed at 25°. The distance s from the lidar (2) to the cover (3) varies from 35 mm to 115 mm. Simulations indicate that the baffle (4) has to be placed closer to the lidar (2) if the cover (3) is place further from the lidar (2). In other terms, as the distance s between the lidar (2) and the cover (3) increases, the distance d between the lidar (2) and the baffle (4) decreases in order to cut, or at least reduce, the reflection noise.

FIG. 6 shows results of another simulation, where the distance s from the lidar (2) to the cover (3) is fixed at 75 mm and the angle A between the cover (3) and the optical axis (21) of the lidar (2) varies from 20° to 80°. Simulations show that the baffle (4) could be placed a little further away from the lidar (2) as the angle A increases from 20° to 50°. Beyond 50°, the baffle (4) has to be placed closer to the lidar (2).

Regarding integration of a lidar (2) behind a windshield, the inclination of the windshield is usually between 25° and 40°. As the lidar (2) is placed at an angle usually 5° smaller than the windshield, the angle A is therefore between 20° and 35°. The maximal distance of distanced is so chosen between 25 and 40 mm.

While the invention has been illustrated and described in detail in the drawings and foregoing description, such illustration and description are to be considered illustrative or exemplary and not restrictive. The foregoing description details certain embodiments of the invention. It will be appreciated, however, that no matter how detailed the foregoing appears in text, the invention may be practiced in many ways. The invention is not limited to the disclosed embodiments.

1. A detection device comprising:
a. a sensing device comprising:
i. an emitter emitting along an emitting axis;
ii. a receiver receiving along a receiving axis;
both the emitter and the receiver operating within a wavelength range; the sensing device having a sensing axis defined as a center axis between the emitting axis and the receiving axis; the sensing device having a field of view; the sensing device having an opening through which a wave within the wavelength range passes;
b. a cover facing the opening of the sensing device, defining an angle A with the sensing axis of the sensing device; the cover being transparent at the operating wavelength range of the sensing device (2);
c. a baffle placed at a distance d from the sensing axis of the sensing device measured at the opening of the sensing device; the baffle extending towards the cover; the baffle defining an angle B with the cover and defining an angle C with the sensing axis of the sensing device; the baffle being placed outside the field of view of the sensing device;
wherein the distance d is determined in a way that an intensity of a wave which is scattered by the baffle back to the cover and then reflected by the cover to be detected by the receiver of the sensing device is a maximum of 50% of the intensity of the wave emitted by the emitter of the sensing device and then reflected by the cover towards the baffle.

2. The detection device according to claim 1, wherein the baffle is parallel to the sensing axis of the sensing device.

3. The detection device according to claim 1, wherein the baffle is part of a bracket to integrate the sensing device or a surrounding component of the sensing device.

4. The detection device according to claim 1, wherein the sensing device is a radar.

5. The detection device according to claim 1, wherein the sensing device is a lidar.

6. The detection device according to claim 5, wherein a wavelength range of the sensing device is comprised between 750 nm and 1650 nm.

7. The detection device according to claim 1, wherein the cover is made of glass.

8. The detection device according to claim 7, wherein the cover has an absorption coefficient lower than 15 m⁻¹ in a wavelength range from 750 to 1650 nm.

9. The detection device according to claim 1, wherein the cover is at least a portion of an automotive glazing or an automotive applique or an automotive trim element.

10. The detection device according to claim 1, wherein the cover is placed behind an automotive glazing or an automotive applique or an automotive trim element.

11. An automotive vehicle comprising the detection device according to claim 1.

12. The automotive vehicle according to claim 11, wherein the sensing device is a lidar.

13. The detection device according to claim 1, wherein the intensity of the wave which is scattered by the baffle back to the cover and then reflected by the cover to be detected by the receiver of the sensing device is 20% of the intensity of the wave emitted by the emitter of the sensing device and then reflected by the cover towards the baffle.

14. The detection device according to claim 1, wherein the intensity of the wave which is scattered by the baffle back to the cover and then reflected by the cover to be detected by the receiver of the sensing device is 10% of the intensity of the wave emitted by the emitter of the sensing device and then reflected by the cover towards the baffle.

15. The detection device according to claim 1, wherein the intensity of the wave which is scattered by the baffle back to the cover and then reflected by the cover to be detected by the receiver of the sensing device is 0% of the intensity of the wave.

16. The detection device according to claim 5, wherein the sensing device is a solid state lidar.

17. The automotive vehicle according to claim 12, wherein the sensing device is a solid state lidar.
